(19) United States
(12) Patent Application Publication
(10) Pub. No.: US 2002/0093167 A1
(43) Pub. Date: Jul. 18, 2002

(54) Scooter skid plate

(76) Inventors: Justin Jones, Laguna Hills, CA (US); David Trauffer, Laguna Hills, CA (US)

Correspondence Address: Drummond & Duckworth, 5000 Birch Street, Suite 440 East Tower, Newport Beach, CA, 92660, US

(21) Appl. No.: 09/759,620

(22) Filed: Jan. 12, 2001

(51) Int. Cl. B62M 1/00

(52) U.S. Cl. 280/87.042; 280/607

(57) ABSTRACT

A skid plate for manually propelled scooters is provided. This skid plate includes a bottom panel, side panels and a front panel for protecting the front, sides and bottom of the platform section of a scooter. Projecting rearwardly from the front panel are one or more nodal projections which are sized and configured to project into hollow stiffening members of a scooter's platform section. In a preferred embodiment, the bottom panel of the skid plate further includes an upwardly extending ridge sized and configured to press fit into a groove formed on the underside of a scooter's platform section.

### BACKGROUND OF THE INVENTION

The present invention relates generally to manually propelled vehicles. More specifically, the invention relates to a skid plate for scooters.

Though manually propelled scooters have been known for over 100 years, recently scooters have obtained previously unknown popularity. Typical scooters known in the prior art include a low, narrow platform section having a pair of tabular hollow stiffening members. The stiffening members extend the length of the platform section and have a groove formed between them. The scooter also has one or two wheels attached to the front and rear of the platform. Typically, the rear wheel is attached to a rigid rear fork which extends from the back of the platform section so that it cannot turn left or right. Meanwhile, the front wheels, are attached to the platform section by a steering assembly. The steering assembly includes a head tube which is affixed or hingeably connected to the front of the platform section. Telescoping through the head tube is a steering column which may be constructed of multiple telescoping pieces. The steering assembly further includes horizontally extending handlebars which are attached to the uppermost extremity of the steering column which enable a rider to steer the scooter by manually rotating the steering column about the vertical axis. Attached to the bottom of the steering column is a front fork for affixing a front wheel.

These scooters provide a lightweight collapsible structure which is propelled by a rider who holds on to the handles and places one foot upon the platform section and propels himself and the scooter forward by a series of pushes made by the other foot against the ground. Coasting is accomplished by placing both feet upon the board, one foot forward of the other while the scooter is in motion. Steering is accomplished by rotating the steering column using the handlebars to rotate the front wheel.

Though these manually propelled scooters are relatively simplistic and easy to operate, they have also proven to be quite dangerous today as thousands of children are injured every year while operating these scooters. One significant cause of accidents is due to the fact that due to the scooter's relatively small wheel diameter and small scooter ground clearance, when a scooter rides over a vertical variation in the riding surface, the bottom of the platform section will often engage the ground. For example, when a scooter is ridden over a speed bump or sidewalk curb, the front wheel of the scooter will typically roll easily over the bump or curb, but the front wheel will be of a diameter insufficient to keep the underside of the platform section from engaging the speed bump or curb. When this occurs, the scooter will usually come to a grinding halt with the rider being propelled over the handlebars. As a result of the scooter coming to a grinding halt, serious injuries have occurred.

Thus, there has been a need to provide a means for reducing accidents caused by the scooter coming to an inadvertent stop upon the platform section engaging the ground. To this end, it has been known to attach a metal plate to the bottom of the platform section of the scooter to provide a smoother surface for engaging the ground. Though somewhat successful at reducing the risk of injuries occurring when a scooter encounters a bump or curb, the prior art skid plates are difficult to install requiring the drilling of holes into the scooter for the attachment of screws or bolts. In addition, the metal surface of the skid plate has been found to have a relatively high coefficient of friction which causes the scooter to still significantly reduce speed when a skid plate engages the ground. Moreover, though the prior art skid plates protect the bottom of the scooter's platform section against damage, the sides of the platform section are still susceptible to damage from scraping against the ground.

There is thus a need for an improved scooter skid plate which is easily and quickly installed to the bottom of the scooter.

Moreover, there is a need for an improved skid plate for scooters which slides efficiently after engaging the ground.

In addition, it would be preferable if a skid plate were provided that not only protected the bottom of a scooter's platform section, but the sides as well.

### SUMMARY OF THE INVENTION

Briefly, and in general terms, the present invention addresses the aforementioned disadvantages by providing an improved scooter skid plate.

The scooter skid plate includes a bottom panel for underlying the platform section of the scooter. In addition, the skid plate includes a pair of side panels which project upwardly from the sides of the bottom panel of the skid plate. The side panels extend to substantially cover the sides of the scooter's platform section; and they can be constructed in various configurations such as being planar or curved depending on the construction of the scooter.

The skid plate of the present invention further includes a front panel affixed to the front edges of the bottom panel and side panels. The front panel is sized to cover the front of the scooter's platform section, and further includes a pair of nodal projections which project rearwardly. The nodal projections are sized and configured to project into hollow stiffening members which extend longitudinally the length of a scooter's platform section. Preferably, the nodal projections are sized to provide a “press-fit” engagement with the hollow stiffening members.

Many scooters include a longitudinal groove which is formed on the bottom of the scooter's platform section between the hollow stiffening members. The groove typically extends substantially the length of the platform. Where the scooter includes such a construction, the skid plate of the present invention preferably includes a vertically extending ridge which is sized and configured to reside within the scooter's groove when the skid plate is affixed to the scooter. Preferably, the ridge is also sized to provide a press fit within the scooter's groove to further provide attachment of the skid plate to the scooter. In this manner, utilizing the press fit between the nodal projections and the interior of the hollow stiffening members and the press fit between the skid plate's ridge with the groove formed along the bottom of the scooter's platform section, the skid plate can be affixed to a scooter without utilizing any additional fasteners such as screws, bolts or bonding materials, and without causing any destruction such as drilling of holes to the scooter.

The present invention also provides protection to the sides of the scooter's platform section as well as the bottom. Moreover, the skid plate is inexpensive to manufacture and easily installed.

Other features and advantages of the present invention will be appreciated by those skilled in the art upon reading the detailed description which “cause?? To the attached drawings.

### BRIEF DESCRIPTION OF THE DRAWINGS

These and other features, aspects and advantages of the present invention will become better understood with regard to the following description, appended claims, and accompanying drawings where:

FIG. 1 is a frontal perspective view illustrating the mode of attaching the skid plate of the invention to a scooter;

FIG. 2 is a rear perspective view illustrating the attachment of the skid plate of the present invention to a scooter;

FIG. 3 is a frontal perspective view illustrating the skid plate of the present invention attached to a scooter;

FIG. 4 is a top view of the skid plate of the present invention;

FIG. 5 is a front elevation view of the skid plate of the present invention;

FIG. 6 is a rear elevation view of the skid plate of the present invention;

FIG. 7 is a left elevation view of the skid plate of the present invention;

FIG. 8 is a bottom plan view of the skid plate of the present invention;

FIG. 9 is a right elevation view of the skid plate of the present invention;

FIG. 10 is a frontal perspective view illustrating the mode of attaching a second embodiment of the skid plate of the invention to a scooter;

FIG. 11 is a rear perspective view illustrating the attachment the second embodiment of the skid plate shown in FIG. 10 to a scooter; and

FIG. 12 is a frontal perspective view illustrating the skid plate shown in FIG. 10 of the present invention attached to a scooter.

### DETAILED DESCRIPTION OF THE INVENTION

While the present invention is susceptible of embodiment in various forms, there is shown in the drawings and will here and after be described the presently preferred embodiment of the invention with the understanding that the present disclosure is considered to be an exemplification of the invention and is not intended to limit the invention to the specific embodiments illustrated.

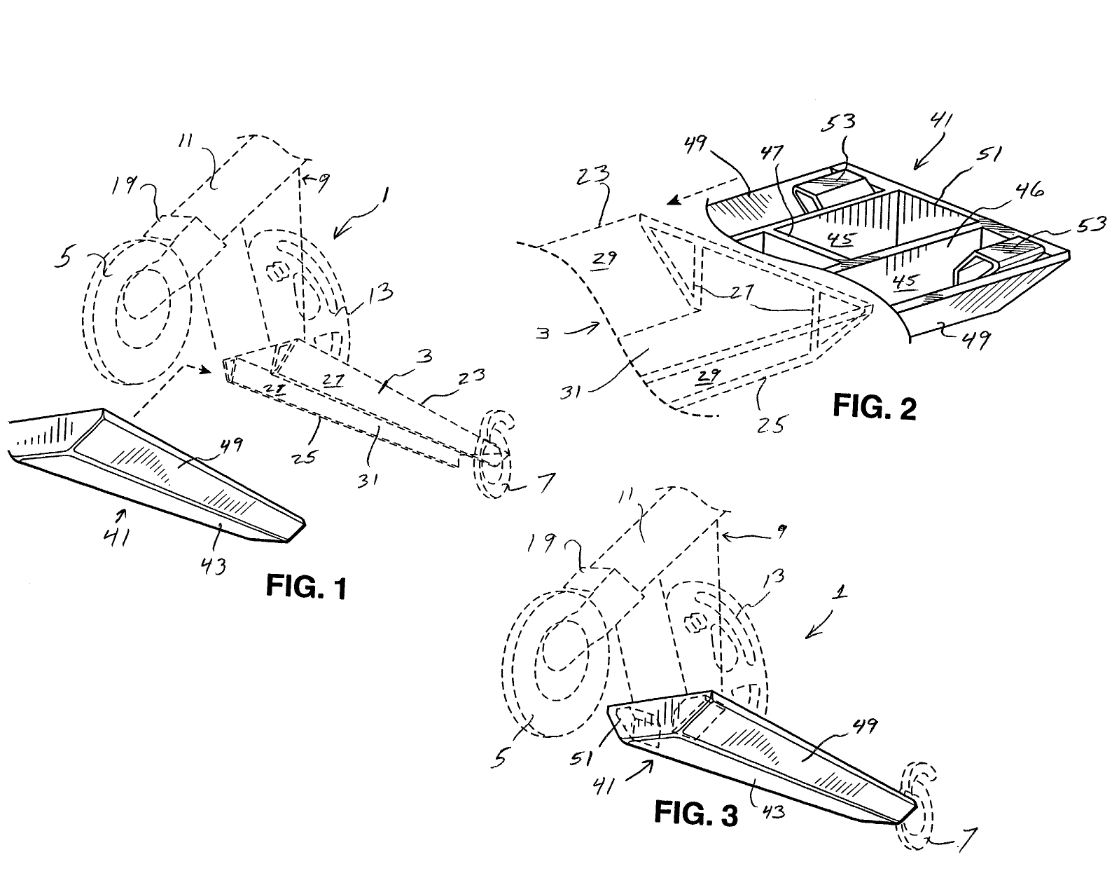

As shown in FIGS. 1-3 and FIGS. 10-12, the skid plate 41 of the present invention is intended for use as a skid plate for a manually propelled scooter 1. Generally, the scooter 1 includes a platform section 3, steering assembly 9, and front and rear wheels, 7 and 9, respectively. Platform section includes at least one, and preferably 2, hollowed stiffening members 27 which extend the length of the platform section for providing stiffness and for supporting a rider's weight upon the platform section. The platform section 23 is typically rectangular and includes a top surface 23 upon which a rider places his feet and a bottom surface 25 adjacent to the ground, between which the hollow stiffening members 27 are disposed. The platform section also includes sides 29.

Meanwhile, the scooter's steering assembly 9 typically includes a head tube 11 which is attached to the front of the platform section 3 by a hinge 13 which allows the steering assembly head tube at its bottom extremity to rotate about the lateral axis. Telescoping through the head tube 11 is a steering column (not shown) which may be collapsible so as to take up less space during storage. At the top of the steering column are handlebars (not shown).

A typical scooter 1 further includes at least a single rear wheel 7 and a single front wheel 5, though scooters with additional wheels are also common. The rear wheel is attached to the rear of the platform section 23 by a rear fork. Meanwhile, the front wheel 5 is connected to the scooter 1 by a front fork 19 which extends downwardly from the steering column. Rotation of the handlebars and steering column causes rotation of the front wheel about the vertical axis so as to enable a rider to steer the scooter.

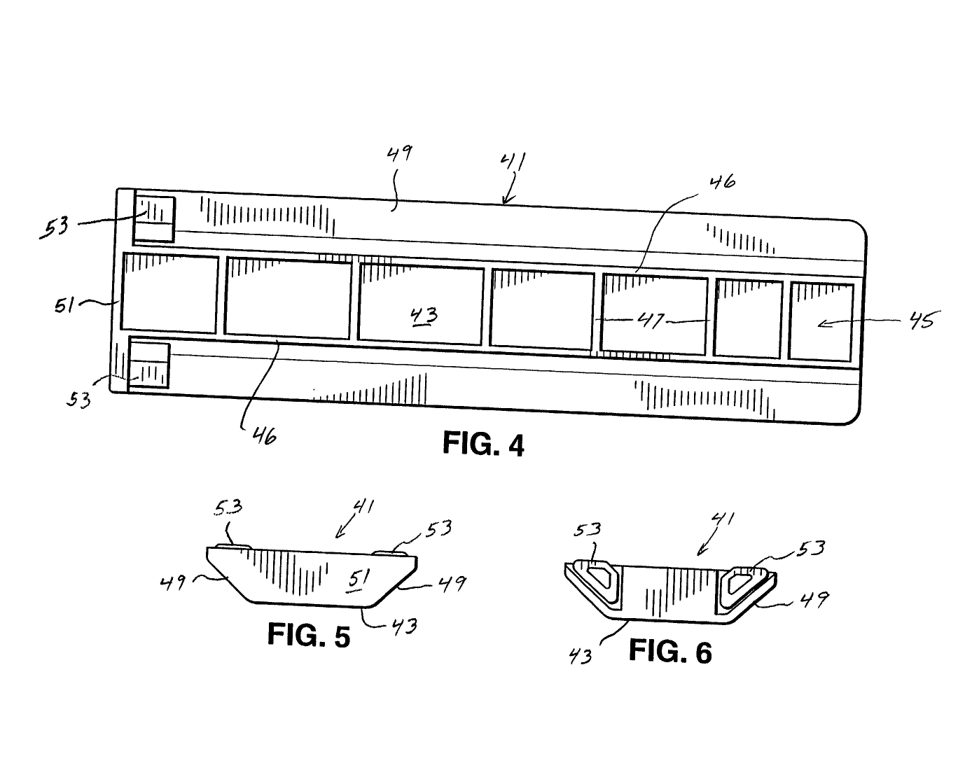

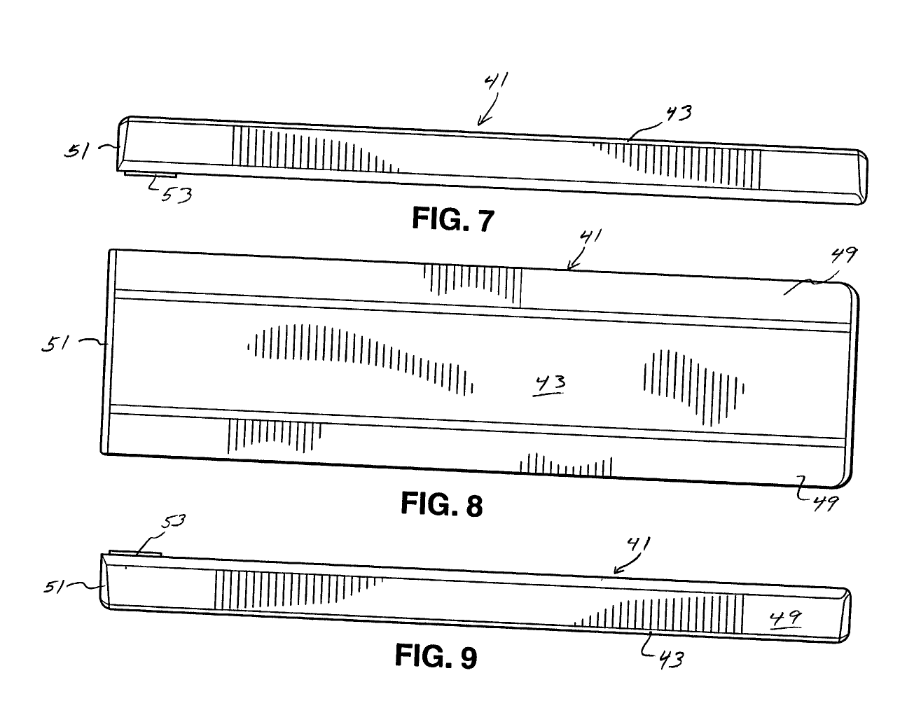

With reference to FIGS. 1-12, the skid plate 41 of the present invention includes a bottom panel 43. In a preferred embodiment, the bottom panel includes a ridge 45 comprised of longitudinal members 46 and cross members 47 which are sized and configured to project into the groove 31 formed on the underside of a scooter's platform section 23. Preferably, the ridge 45 resides within the scooter's groove 31 in a press fit connection so as to affix the skid plate in place.

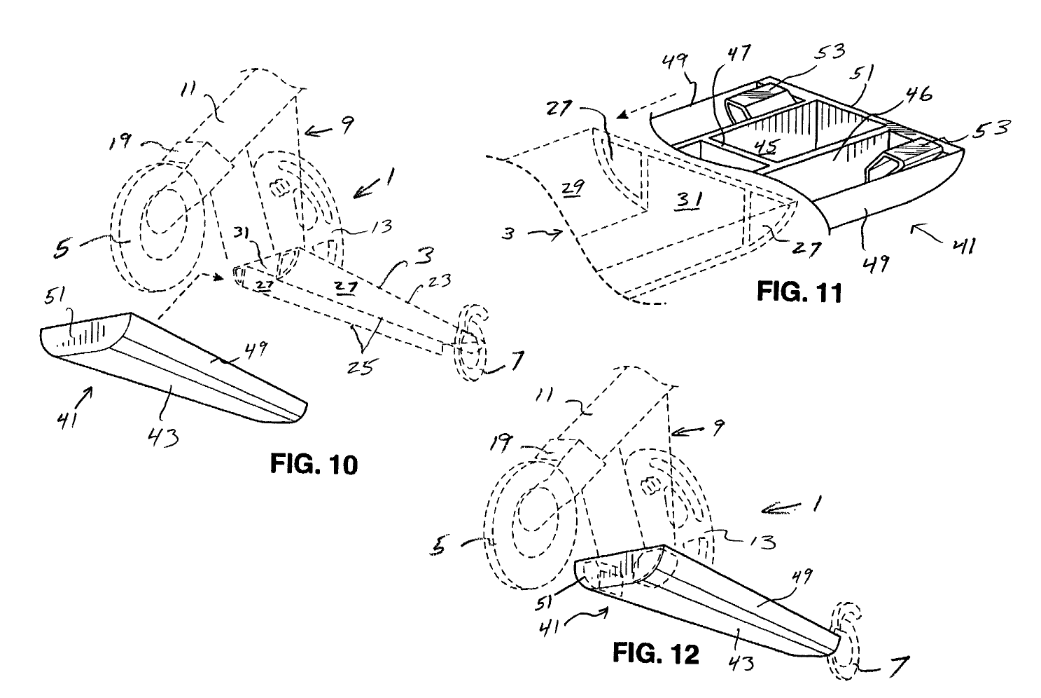

The skid plate 41 of the present invention further includes left and right side panels 49 which project upwardly from the sides of the bottom panel 43. The side panels are constructed to engage and protect the sides of the platform section 23 of the scooter when the skid plate isn't stalled. The side panels may be generally planar, as shown in the FIGS. 1-3, or may be constructed having various shapes depending on the construction of the scooter. For example, as shown in FIGS. 10-12, numerous models of scooters include a platform section having curved sides. A skid plate 41 used in cooperation with such a scooter would thus include curved side panels 49.

The skid plate of the present invention also includes a front panel 51. The front panel engages the front edges of the bottom panel 43 and side panels 41 and extends vertically to cover and protect the front of the scooter's platform section 3 when installed. Of significance, the front panel 51 includes at least one nodal projection which is sized and configured to project into the hollow region of a scooter's stiffening members 27. With reference again to FIGS. 1-3 and FIGS. 1-12, in a preferred embodiment, the skid plate 41 includes 2 nodal projections 53 sized and configured to project into a pair of hollow stiffening members 27 formed on the underside of the scooter's platform section 23.

The skid plate 41 can be installed upon a scooter 1 without requiring the addition of any additional fasteners, such as nut and bolt combinations, screws, or bonding materials. Instead, to install the skid plate 41 upon the underside of the platform section 3 of the scooter, the nodal projections 53 are forced into the hollow regions of the stiffening members 27 with the bottom panel 43 of the skid plate positioned under the scooter's platform section 3 and the skid plate's side panels 49 positioned alongside the sides 29 of the platform section. As the nodal projections are forced into the hollowed stiffening members, the ridge 45 formed upon the bottom panel 43 is simultaneously forced into the groove 31 formed on the platform section's underside. Due to a press fit between the various components, the skid plate cannot be removed without significantly greater force than encountered during typical riding of the scooter.

The skid plate of the present invention may be constructed of various materials such as metals, wood or plastic. However, a preferred material for manufacturing the skid plate is high molecular weight polyethylene. Polyethylene is found to be particularly acceptable for use as a skid plate due to its excellent durability and low coefficient of friction with respect to most ground surfaces.

Although the present invention has been described with reference to the preferred embodiments, workers skilled in the art will recognize that changes maybe made in form and detail without departing from the spirit and scope of the invention. Accordingly, it is not intended that the invention be limited, except by the following claims.

We claim:

1. A skid plate for scooters having a front wheel, a rear wheel, a steering column for steering the front wheel, and a platform section having a top surface vertically separated from a bottom surface, the skid plate comprising:
a bottom panel for underlying the bottom surface of a scooter; and
a pair of side panels projecting upwardly from said bottom panel and constructed to the extend substantially from the bottom surface of the scooter to the top surface of the scooter.

2. The skid plate of claim 1 wherein said skid plate is configured to affix to a scooter having an upwardly projecting groove longitudinally extending along at least part of the length of the scooter's bottom surface, the skid plate's platform section including a ridge constructed to project at least partially into the scooter's groove.

3. The skid plate of claim 2 wherein said ridge substantially fills the scooter's groove.

4. The skid plate of claim 1 being constructed of high molecular weight polyethylene.

5. A skid plate for scooters having a front wheel, a rear wheel, a steering column for steering the front wheel, a platform section having at least one longitudinally extending hollow stiffening members separating the platform section's top surface from the platform section's bottom surface, the skid plate comprising:
a bottom panel for underlying the bottom surface of a scooter; and
at least one nodal projections connected to said bottom panel, said nodal projections sized and configured to project into the hollow stiffening members to affix said skid plate to the scooter.

6. The skid plate of claim 5 wherein said skid plate is configured to affix to a scooter having an upwardly projecting groove longitudinally extending along at least part of the length of the scooter's bottom surface, the skid plate's platform section including a ridge constructed to project at least partially into the scooter's groove.

7. The skid plate of claim 6 wherein said ridge substantially fills the scooter's groove.

8. The skid plate of claim 5 being constructed of high molecular weight polyethylene.

9. The skid plate of claim 5 including a pair of nodal projections sized and configured to project into a pair hollow stiffening members to affix said skid plate to the scooter.

10. A skid plate for scooters having a front wheel, a rear wheel, a steering column for steering the front wheel, a platform section having at least one longitudinally extending hollow stiffening members separating the platform section's top surface from the platform section's bottom surface, the skid plate comprising:
a bottom panel for underlying the bottom surface of a scooter;
a pair of side panels projecting upwardly from said bottom panel and constructed to the extend substantially from the bottom surface of the scooter to the top surface of the scooter; and
at least one nodal projection connected to said bottom panel, said nodal projections sized and configured to project into the hollow stiffening members to affix said skid plate to the scooter.

11. The skid plate of claim 10 wherein said skid plate is configured to affix to a scooter having an upwardly projecting groove longitudinally extending along at least part of the length of the scooter's bottom surface, the skid plate's platform section including a ridge constructed to project at least partially into the scooter's groove.

12. The skid plate of claim 11 wherein said ridge substantially fills the scooter's groove.

13. The skid plate of claim 10 being constructed of high molecular weight polyethylene.

14. The skid plate of claim 10 including a pair of nodal projections sized and configured to project into a pair hollow stiffening members to affix said skid plate to the scooter.
